(19) United States
(12) Patent Application Publication
(10) Pub. No.: US 2014/0316851 A1
(43) Pub. Date: Oct. 23, 2014

(54) PREDICTING CUSTOMER RECEPTIVITY FOR COMMERCIAL ENGAGEMENT

(71) Applicant: International Business Machines Corporation, Armonk, NY (US)

(72) Inventors: Yurdaer N. Doganata, Chestnut Ridge, NY (US); Tomas A. Masaguer, Barcelona (ES); Jordi C. Mestre, Barcelona (ES)

(73) Assignee: International Business Machines Corporation, Armonk, NY (US)

(21) Appl. No.: 14/247,338

(22) Filed: Apr. 8, 2014

(30) Foreign Application Priority Data
Apr. 23, 2013 (EP) 13382148.8

(51) Int. Cl. G06Q 30/02

(52) U.S. Cl. CPC G06Q 30/0201
USPC 705/7.29

(57) ABSTRACT

In an exemplary embodiment of this disclosure, a computer-implemented method includes storing in a rules database one or more rules related to customer receptivity. A first subset of the rules is processed, by a computer processor, to determine a computed level of customer receptivity (LOCR) for each of one or more customers. One or more observed LOCRs are received for the one or more customers. Each observed LOCR may be based on contact with a corresponding customer of the one or more customers. One or more predicted LOCRs are predicted for the one or more customers, using one or more predictive models. Each predicted LOCR is based at least in part on an observed LOCR associated with the corresponding customer of the one or more customers. The rules in the rules database are then modified, repeatedly, to reflect the predicted LOCRs and additional predicted LOCRs after they are predicted.

### PRIORITY

This application claims priority to European Patent Application No. 13382148.8, filed 23 Apr. 2013, and all the benefits accruing therefrom under 35 U.S.C. §119, the contents of which in its entirety are herein incorporated by reference.

### BACKGROUND

Various embodiments of this disclosure relate to marketing and, more particularly, to predicting customer receptivity to determine when to contact a customer for a commercial engagement.

Contacting customers for commercial purposes may damage a company's reputation if the customers are not ready to engage at the time of contact. On the other hand, when the contact is done under proper conditions and at the proper time, the level of customer satisfaction increases, thus improving the company's brand reputation. Businesses would like to increase customer satisfaction with new product offerings, while also leveraging brand reputation.

Some conventional solutions exist for determining whether to contact customers. One solution uses leads worksheets that are based on prior interactions with certain customers. From the prior interactions, instructions for next steps are generated automatically. Other solutions predict commercial engagement opportunities by collecting contextual information associated with the customers based on the customers' activity pattern.

### SUMMARY

In one embodiment of this disclosure, a computer-implemented method includes storing in a rules database one or more rules related to customer receptivity. A first subset of the rules is processed, by a computer processor, to determine a computed level of customer receptivity (LOCR) for each of one or more customers. One or more observed LOCRs are received for the one or more customers. Each observed LOCR may be based on contact with a corresponding customer of the one or more customers. One or more predicted LOCRs are predicted for the one or more customers, using one or more predictive models. Each predicted LOCR is based at least in part on an observed LOCR associated with the corresponding customer of the one or more customers. The rules in the rules database are then modified, repeatedly, to reflect the predicted LOCRs and additional predicted LOCRs after they are predicted.

In another embodiment, a system includes a rules database, a computer processor, a rule generation unit, and a prediction unit. The rules database contains one or more rules related to customer receptivity. The computer processor is configured to process a first subset of the rules to determine a computed LOCR for each of one or more customers. The rule generation unit is configured to receive one or more observed LOCRs for the one or more customers, where each observed LOCR is based on contact with a corresponding customer of the one or more customers. The prediction unit is configured to predict one or more predicted LOCRs for the one or more customers, using one or more predictive models. Each predicted LOCR is based at least in part on an observed LOCR associated with the corresponding customer of the one or more customers. The rule generation unit modifies the rules in the rules database, repeatedly, to reflect the predicted LOCRs and additional predicted LOCRs after they are predicted.

In yet another embodiment, a computer program product includes a computer readable storage medium having computer readable program code embodied thereon. The computer readable program code is executable by a processor to perform a method. The method includes storing in a rules database one or more rules related to customer receptivity. Also according to the method, a first subset of the rules is processed to determine a computed LOCR for each of one or more customers. One or more LOCRs are received for the one or more customers. Each observed LOCR may be based on contact with a corresponding customer of the one or more customers. One or more predicted LOCRs are predicted for the one or more customers, using one or more predictive models. Each predicted LOCR is based at least in part on an observed LOCR associated with the corresponding customer of the one or more customers. The rules in the rules database are then modified, repeatedly, to reflect the predicted LOCRs and additional predicted LOCRs after they are predicted.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a computing device useable with a prediction system, according to an exemplary embodiment of this disclosure;

FIG. 2 is a block diagram of a prediction system, according to an exemplary embodiment of this disclosure; and

FIG. 3 is a flow diagram of a method for predicting a level of customer receptivity, according to an exemplary embodiment of this disclosure.

### DETAILED DESCRIPTION

Various embodiments of this disclosure use an iterative process to predict customer receptivity to commercial contact at various times and under various conditions. If a computed level of customer receptivity for a sales call is low, customer contact may be postponed until the customer's computed receptivity is high. An exemplary embodiment uses dynamic updates based on personal attributes, life events, and prior displayed receptivity of a customer to place effective cold calls or other forms of contact. The result may be an improvement in customer satisfaction and brand reputation.

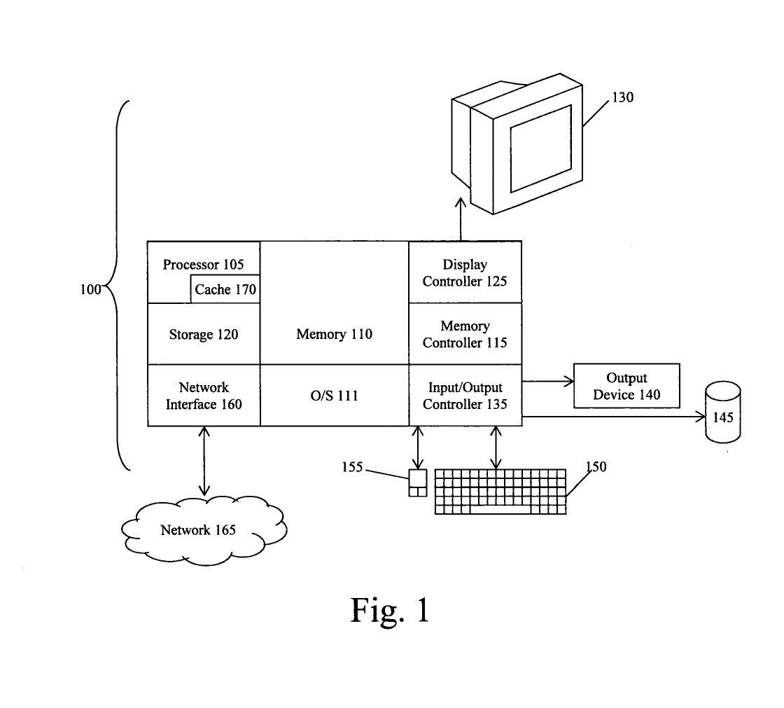

FIG. 1 illustrates a block diagram of a computer system 100 for use in implementing a prediction system or method according to some embodiments. The prediction systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 100, such as a personal computer, workstation, minicomputer, or mainframe computer.

In an exemplary embodiment, as shown in FIG. 1, the computer system 100 includes a processor 105, memory 110 coupled to a memory controller 115, and one or more input and/or output (I/O) devices 140 and 145, such as peripherals, that are communicatively coupled via a local I/O controller 135. The I/O controller 135 may be, for example but not limitation, one or more buses or other wired or wireless connections, as are known in the art. The I/O controller 135 may have additional elements, which are omitted for simplicity, such as controllers, buffers (caches), drivers, repeaters, and receivers, to enable communications.

The processor 105 is a hardware device for executing hardware instructions or software, particularly those stored in memory 110. The processor 105 may be any custom made or commercially available processor, a central processing unit (CPU), an auxiliary processor among several processors associated with the computer system 100, a semiconductor based microprocessor (in the form of a microchip or chip set), a macroprocessor, or other device for executing instructions. The processor 105 includes a cache 170, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 170 may be organized as a hierarchy of more cache levels (L1, L2, etc.).

The memory 110 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive.

In an exemplary embodiment, a conventional keyboard 150 and mouse 155 may be coupled to the I/O controller 135. Other output devices such as the I/O devices 140 and 145 may include input devices, for example but not limited to, a printer, a scanner, a microphone, and the like. The I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like.

The computer system 100 may further include a display controller 125 coupled to a display 130. In an exemplary embodiment, the computer system 100 may further include a network interface 160 for coupling to a network 165. The network 165 may be an IP-based network for communication between the computer system 100 and any external server, client and the like via a broadband connection. The network 165 transmits and receives data between the computer system 100 and external systems. In an exemplary embodiment, the network 165 may be a managed IP network administered by a service provider. The network 165 may be implemented in a wireless fashion, e.g., using wireless protocols and technologies, such as WiFi, WiMax, etc. The network 165 may also be a packet-switched network such as a local area network, wide area network, metropolitan area network, the Internet, or other similar type of network environment. The network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

Systems and methods according to this disclosure may be embodied, in whole or in part, in computer program products or in computer systems 100, such as that illustrated in FIG. 1.

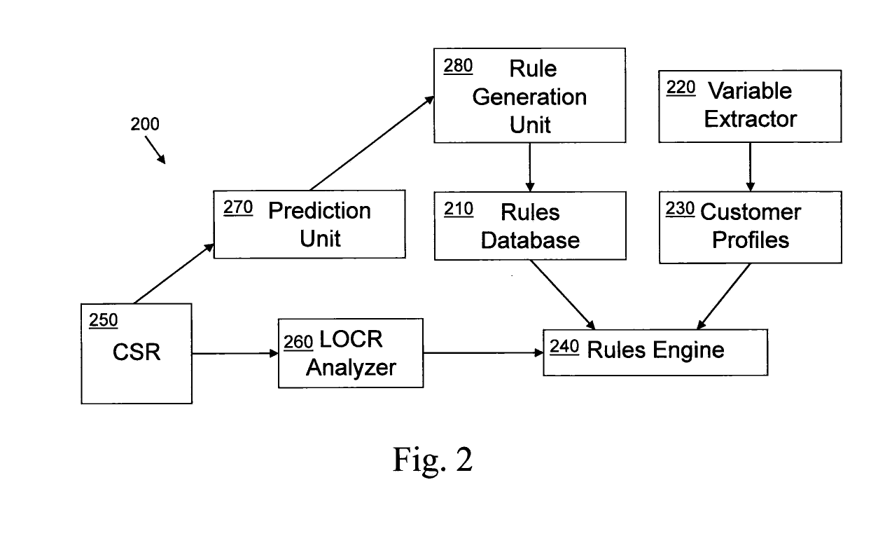

FIG. 2 is a block diagram of a prediction system 200, according to some embodiments. As shown, the prediction system 200 may include a rules database 210, a variable extractor 220, a rules analyzer 240, a level of contact receptivity (LOCR) analyzer 260, a prediction unit 270, and a rule generation unit 280. It will be understood that these aspects of the prediction system 200 need not be distinct components from one another. Rather, the rules database 210, the variable extractor 220, the rules analyzer 240, the LOCR analyzer 260, the prediction unit 270, and the rule generation unit 280 may comprise overlapping hardware, software, or a combination thereof.

The rules database 210 may maintain one or more rules, which together are used to predict customers' LOCRs. It will be understood that the term “database,” as used herein, need not be limited to a relational database. Rather, this term may refer to various means for organizing data for retrieval by other aspects of the prediction system 200.

Experts in the field of marketing may assist in devising the rules, and each rule may provide an indication of a customer's LOCR based on the values of one or more variables related to that customer. Application of a rule to a particular customer may require knowledge of the values of those variables. The variable extractor 220 may receive data from one or more data sources and may extract the values of the needed variables, storing these values in customer profiles 230. Each customer may thus be associated with a customer profile 230 that contains a unique customer identifier, as well as one or more attributes that correspond to the variable values for the various rules in the rules database 210. As needed, the rules engine 240 may access the rules in the rules database 210 and the customer profiles 230 to apply the rules to the customer profiles 230.

A customer service representative (CSR) 250 may desire to contact, or to schedule future contact, customer for marketing purposes. To that end, the CSR submits a query to the LOCR analyzer 260. The LOCR analyzer 260 may determine which rules need to be applied and to which customers, and may then instruct the rules engine 240 to apply those rules to the customers. The rules engine 240 may process the rules, as per the LOCR analyzer's instructions, and return the output to the LOCR analyzer 260. The LOCR analyzer 260 may then respond to the CSR's query.

After receiving results from the LOCR analyzer 260, the CSR 250 may contact one or more customers in accordance with the results. For example, if the LOCR analyzer 260 predicts that certain customers currently have high LOCRs, the CSR 250 may contact those customers. After contact is made, the CSR 250 may record his or her impressions about the observed LOCRs, which are the LOCRs actually observed during the contact.

The prediction unit 270 may determine the most likely values of LOCRs under certain conditions, for each customer. The prediction unit 270 may utilize a plurality of predictive models, where each predictive model corresponds to a rule in the rules database 210. Based on one or more observed LOCRs for a particular customer, the predictive unit 280 may use the predictive models to output a predicted LOCR. In some embodiments, the prediction unit 270 may withhold making a prediction for a customer until multiple observed LOCRs exist for that customer, so that a sufficient basis for prediction is provided. Additionally, in some embodiments, the prediction unit 270 may exclude outliers from its calculations of predicted LOCRs.

If a predicted LOCR differs from the computed LOCR for that customer, the rule generation unit 280 may update the rules in the rules database 210 to better reflect reality. The rule generation unit 280 may be informed by the experts, who may review the predicted LOCRs and assist in modifying the rules.

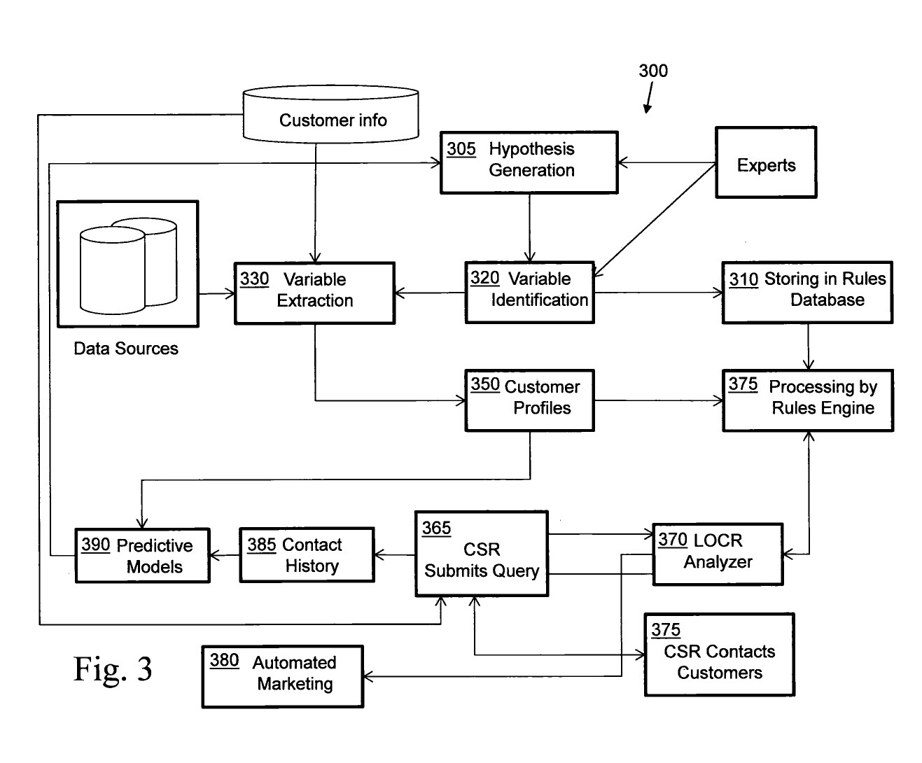

FIG. 3 illustrates a flow diagram of a method 300 for predicting LOCRs, according to some embodiments of this disclosure. As shown, the method 300 may include a closed loop, beginning with initial hypotheses and rule generation, at block 305. The initial hypotheses may be based on assumptions about customers' reactions to sales calls, market research, and feedback from call centers. The initial set of hypotheses may be generated based on responses questions posed and answered manually by experts in the field of customer relations. These questions may be devised to determine rules about how customers behave. For example, such questions may include: Is a customer's LOCR high when he or she gets a promotion? Are female customers more likely than male customers to have higher LOCRs in the morning?

Hypothesis statements may be devised by the experts based on their answers to these questions. Some hypothesis statements may be, for example: A customer's LOCR is higher when he or she gets a promotion. If a customer is female, and it is morning, the customer's LOCR is high. If the customer has a child less than five years old, the customer's age is less than forty, and it is not a summer month, then the customer's LOCR before 6:00 p.m. is high.

Hypothesis statements may be provided in natural language. For computational convenience, variables may then be identified from hypothesis statements, at block 320. Variable identification may be performed manually, automatically, or semi-manually. For semi-manual identification, each hypothesis statement may be input into a text analysis tool, which may tag part-of-speech components for convenience, thus making it easier for experts to identify the potential variables.

For example, given the hypothesis “If the customer has a child less than five years old, the customer's age is less than forty, and it is not a summer month, then the customer's LOCR before 6:00 p.m. is high,” the following variables may be identified, as their values would need to be known to apply the hypothesis statement to a customer: CustomerHasChildren (boolean), CustomerAge (integer), CustomerChildAge (string), Season (value of Summer, Winter, Spring, or Fall), and Time (time).

After the variables are identified, the hypothesis statement may be converted into a rule. Again, this may be performed manually, semi-manually, or automatically. In an exemplary embodiment, a rule is a mathematical expression that has the same truth value as the hypothesis statement, written in terms of the identified variables. The rule associated with the hypothesis statement for which variables were identified above may be, for example: If {CustomerChildren>0 and CustomerAge<40 and CustomerChildAge<5 and Season=Fall and Time <6:00 p.m.} then LOCR is high. The rules that are generated based on the hypothesis statements may be stored in the rules database 210.

The value of an LOCR may be provided in various formats or domains, based on implementation. For example, LOCR may be low, medium, or high. Alternatively, the LOCR maybe a number value, where a higher number represents a higher degree of receptivity. In that case, each rule may output a numerical value to be added to the cumulative LOCR, where the customer's total LOCR is the average or sum of all applied rules.

The various rules determined from the hypotheses may be stored in the rules database 210, at block 310. The rules database may maintain and organize the rules for efficient access by the rules engine 240.

To apply a rule to a customer, the values of the variables associated with the customer may first be extracted from various sources, at block 330. In the rule given above, for example, at least the age of customer, whether the customer has children, and the age of customer's children may need to be determined for each customer to which the rule is applied. Various data sources, which may be external sources, internal sources, or both, may provide data to the prediction system 200 for determining extracting the values of the variables. Internal sources may include internal records associated with the system manager or operator. For example, if the prediction system 100 is managed or operated by a mobile service company for determining when to contact its customers, the internal data sources may be customer records or preferences related to mobile usage and services. External data sources may include, for example, publicly available data on social networks and web pages, such as Facebook, Twitter messages, public government records, and real estate records. At block 330, these various data sources may be analyzed, and the variable values may be extracted from the supplied data. This extraction may be performed be conventional methods of text analysis and data extraction.

At block 350, the extracted variable values may be stored in customer profiles, where each profile is associated with a customer whose LOCR is to be predicted. A customer profile may be implemented by various means. For example, and not by way of limitation, each customer profile may be represented by a row in a table. In such a table, a first column may represent a customer identifier, and the other columns may each represent a customer attribute, where each attribute is a variable value for use in the rules.

At block 365, a CSR 250 may submit a query to the LOCR analyzer 260 regarding the LOCR of one or more customers. For example, and not by way of limitation, the CSR 250 may request the best times to call one or more specified customers, or may request a list of customers whose LOCRs are currently high. The request will likely depend on the CSR's current needs, informed by currently known information about customers. The CSR 250 may access the LOCR analyzer 260 through a user interface, such as a command prompt or the graphical user interface of a software application or web page.

At block 370, the LOCR analyzer 260 may analyze the CSR's query and determine which rules are applicable and to which customers. The LOCR analyzer 260 may then direct the rules engine 240 to apply such rules to those customers.

Upon request from the LOCR analyzer 260, at block 375, the rules engine 240 may execute one or more rules. This execution may occur in a runtime environment. The rules engine 240 may retrieve the rules, which may be indicated by the LOCR analyzer 260, from the rules database 210. In an exemplary embodiment, the rules engine 240 may support, for example, facts, scoring, mutual exclusion, preconditions, and other functions used to express the rules stored in the rules database 210. The rules engine 240 may apply the rules to the customer profiles 230, as a function of the current date and time or as a function of a date and time provided by the LOCR analyzer 260 based on the CSR's query.

For each query received from a CSR 250, the LOCR analyzer 260 may instruct the rules engine 240 to apply a set of the rules in the rules database 240 and may provide the results to the CSR 250. Additionally, at block 380, output from the LOCR analyzer 260 may be processed automatically and used for automated marketing, such as emails about products. The results may take various forms, which may be dependent on the query originally entered by the CSR 250. For example, if the CSR 250 requested a list of customers to contact at the present time, a list of customers may be returned from the LOCR analyzer 260. Analogously, if the CSR 250 requested the LOCRs of one or more specific customers, a list of those customers and their LOCRs may be returned.

In some embodiments, the LOCR analyzer 260 may output a result in the form of a heat map. A heat map may indicate the LOCR of a customer, not only at the current time, but also with predictions about the near future (e.g. one or two weeks). The heat map may provide a visual timeline indicating the best times and dates to contact the corresponding customer.

After receiving results from the LOCR analyzer 260, at block 375, the CSR 250 may make decisions about which customers to contact in accordance with those results. When the CSR 250 contacts a customer, such as by telephone or other means, the CSR 250 may observe the customer's reaction to the contact. The CSR 250 may then record his or her observations about the customer's LOCR in a customer contact history for the customer, at block 385. At block 390, the customer profiles 230 and the contact history, which includes the observed LOCRs, may be transmitted to the prediction unit 270, which may use a machine learning tool to generate predictive models for customer behavior.

In general, predictive models are created by machine learning techniques to predict the probability of certain outcomes. In an exemplary embodiment, the predictive models may be used to validate or modify the hypotheses provided by the experts at block 305. Each predictive model may correspond to a unique hypothesis generated at block 305 and, as a result, to a unique rule in the rules database 210. The predictive models may be continuously trained with the observed LOCR data, and may output predicted LOCRs based on the predictive models as applied to the observed LOCRs. If observed LOCR values for a particular customer change over time, the predictive models may reflect that change. If there are discrepancies between the computed LOCRs, given by the LOCR analyzer 250, and the predicted LOCRs for one or more customers, the rules in the rules database 210 may be updated to better reflect reality. As with initial rule generation, rule updating may be performed with input from the experts.

After one or more rules are updated and stored back to the rules database 210, the method 300 may proceed iteratively based on the updated rules. Accordingly, rules may be continuously improved based on observed LOCRs, to better predict LOCRs and thereby improve the company's brand.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
storing in a rules database one or more rules related to customer receptivity;
processing, by a computer processor, a first subset of the rules to determine a computed level of customer receptivity (LOCR) for each of one or more customers;
receiving one or more observed LOCRs for the one or more customers, each observed LOCR being based on contact with a corresponding customer of the one or more customers;
predicting one or more predicted LOCRs for the one or more customers, using one or more predictive models applied to the observed LOCRs, each predicted LOCR being based at least in part on an observed LOCR associated with the corresponding customer of the one or more customers; and
modifying the rules in the rules database, repeatedly, to reflect the predicted LOCRs and additional predicted LOCRs after they are predicted.

2. The method of claim 1, further comprising processing a second subset of the rules after modifying the rules in the rules database to reflect the predicted LOCRs for the one or more customers.

3. The method of claim 1, further comprising:
identifying a plurality of variables needed for processing the rules in the rules database; and
extracting a value for each of the variables with respect to a first customer.

4. The method of claim 3, wherein extracting a value for each of the variables with respect to the first customer comprises receiving data about the first customer from one or more publicly available external data sources.

5. The method of claim 1, further comprising devising the one or more rules based on one or more hypotheses, the hypotheses being related to customer receptivity and provided by one or more experts.

6. The method of claim 1, further comprising:
receiving from a customer service representative a query related to the computed LOCRs of the one or more customers;
analyzing the query to identify a subset of the rules that are applicable to the query; and
evaluating the subset of the rules with respect to the one or more customers, in response to the query.

7. The method of claim 6, further comprising outputting, in response to the query, a heat map visually indicating the computed LOCRs of the one or more customers at the present and the near future.

8. A system comprising:
a rules database comprising one or more rules related to customer receptivity;
a computer processor configured to process a first subset of the rules to determine a computed level of customer receptivity (LOCR) for each of one or more customers;
a rule generation unit configured to receive one or more observed LOCRs for the one or more customers, each observed LOCR being based on contact with a corresponding customer of the one or more customers; and
a prediction unit configured to predict one or more predicted LOCRs for the one or more customers, using one or more predictive models, each predicted LOCR being based at least in part on an observed LOCR associated with the corresponding customer of the one or more customers;
wherein the rule generation unit is further configured to modify the rules in the rules database, repeatedly, to reflect the predicted LOCRs and additional predicted LOCRs after they are predicted.

9. The system of claim 8, the computer processor being further configured to process a second subset of the rules after modifying the rules in the rules database to reflect the predicted LOCRs for the one or more customers.

10. The system of claim 8, further comprising a variable extractor configured to identify a plurality of variables needed for processing the rules in the rules database; and
extract a value for each of the variables with respect to a first customer.

11. The system of claim 10, wherein extracting a value for each of the variables with respect to the first customer comprises receiving data about the first customer from one or more publicly available external data sources.

12. The system of claim 8, the rule generation unit being further configured to provide one or more rules based on one or more hypotheses, the hypotheses being related to customer receptivity and provided by one or more experts.

13. The system of clam 8, further comprising:
an LOCR analyzer configured to receive from a customer service representative a query related to the computed LOCRs of the one or more customers, and to analyze the query to identify a subset of the rules that are applicable to the query; and
a rules engine configured to evaluate the subset of the rules with respect to the one or more customers, in response to the query.

14. The system of claim 13, the LOCR analyzer being further configured to output, in response to the query, a heat map visually indicating the computed LOCRs of the one or more customers at the present and the near future.

15. A computer program product comprising a computer readable storage medium having computer readable program code embodied thereon, the computer readable program code executable by a processor to perform a method comprising:
storing in a rules database one or more rules related to customer receptivity;
processing, by a computer processor, a first subset of the rules to determine a computed level of customer receptivity (LOCR) for each of one or more customers;
receiving one or more observed LOCRs for the one or more customers, each observed LOCR being based on contact with a corresponding customer of the one or more customers;
predicting one or more predicted LOCRs for the one or more customers, using one or more predictive models applied to the observed LOCRs, each predicted LOCR being based at least in part on an observed LOCR associated with the corresponding customer of the one or more customers; and
modifying the rules in the rules database, repeatedly, to reflect the predicted LOCRs and additional predicted LOCRs after they are predicted.

16. The computer program product of claim 15, the method further comprising processing a second subset of the rules after modifying the rules in the rules database to reflect the predicted LOCRs for the one or more customers.

17. The computer program product of claim 15, the method further comprising:
identifying a plurality of variables needed for processing the rules in the rules database; and
extracting a value for each of the variables with respect to a first customer.

18. The computer program product of claim 17, wherein extracting a value for each of the variables with respect to the first customer comprises receiving data about the first customer from one or more publicly available external data sources.

19. The computer program product of claim 15, the method further comprising providing the one or more rules based on one or more hypotheses, the hypotheses being related to customer receptivity and provided by one or more experts.

20. The computer program product of claim 15, the method further comprising:
receiving from a customer service representative a query related to the computed LOCRs of the one or more customers;
analyzing the query to identify a subset of the rules that are applicable to the query; and
evaluating the subset of the rules with respect to the one or more customers, in response to the query.
